(19) United States
(12) Patent Application Publication
(10) Pub. No.: US 2025/0128749 A1
(43) Pub. Date: Apr. 24, 2025

(54) TRANSACTION PROCESSING SYSTEM, TRANSACTION PROCESSING DEVICE, AND INFORMATION PROCESSING METHOD

(71) Applicant: Toshiba Tec Kabushiki Kaisha, Tokyo (JP)

(72) Inventors: Suguru KATO, Sunto Shizuoka (JP); Hidehiro NAITO, Mishima Shizuoka (JP)

(21) Appl. No.: 18/888,921

(22) Filed: Sep. 18, 2024

(30) Foreign Application Priority Data
Oct. 19, 2023 (JP) 2023-180315

(51) Int. Cl. B62B 5/00; B62B 3/14; G06V 20/52; G06V 20/60

(52) U.S. Cl. CPC B62B 5/0096; B62B 3/1424; G06V 20/52; G06V 20/60

(57) ABSTRACT

According to one embodiment, a transaction processing system includes a camera positioned on a shopping cart to capture images of merchandise items placed in the shopping cart. A barcode reader is also on the shopping cart to read merchandise codes from merchandise items. A processor is configured to perform object recognition to recognize a merchandise item based on visual features of the merchandise item depicted in an image acquired by the camera. When a merchandise code is read by the barcode reader, the processor registers the merchandise item identified by the merchandise code in a sales transaction. When the merchandise item is recognized by the object recognition, the processor registers the merchandise item in the sale transaction unless the merchandise item recognized by the object recognition is the same merchandise item most recently registered in the sales transaction using the barcode reader.

### CROSS-REFERENCE TO RELATED APPLICATION

This application is based upon and claims the benefit of priority from Japanese Patent Application No. 2023-180315, filed Oct. 19, 2023, the entire contents of which are incorporated herein by reference.

### FIELD

Embodiments described herein relate generally to a transaction processing system, a transaction processing device, and an information processing method for transaction processing systems.

### BACKGROUND

A system in which a merchandise item is recognized and automatically registered for purchase based on a captured image of the merchandise item being put into a shopping cart by a customer has been proposed. Such a system may be referred to as a frictionless cart, an AI (artificial intelligence) cart, a smart cart, an intelligent shopping cart, or the like. However, depending on the state of appearance of the merchandise item in the image, the merchandise item may not be able to be correctly recognized and therefore the automatic registration may not be able to be completed. In view of such circumstances, it is desired to improve the efficiency of registration of a merchandise item in a frictionless cart or the like without substantially increasing the burden on the operator of the cart.

### BRIEF DESCRIPTION OF THE DRAWINGS

FIG. 1 is a block diagram of a transaction processing system according to an embodiment.

FIG. 2 schematically shows a configuration for transaction data.

FIG. 3 is a perspective view showing an example of a cart terminal on a cart.

FIG. 4 is a flowchart of transaction processing.

FIG. 5 is a flowchart of transaction processing.

FIG. 6 shows an example of a guide screen.

FIG. 7 shows an example of a registration screen.

FIG. 8 shows an example of a warning screen.

### DETAILED DESCRIPTION

An embodiment described herein is to provide a transaction processing system, a transaction processing device, and an information processing method that can improve the efficiency of registration of a merchandise item for purchase in a frictionless cart without substantially increasing the burden on the cart operator.

In general, according to one embodiment, A transaction processing system, includes a camera on a cart that is positioned to capture images of merchandise items in a merchandise storage space of the cart. A code reader is on the cart and configured to read merchandise codes from merchandise items. A processor is configured perform object recognition to recognize a merchandise item based on visual features of the merchandise item depicted in an image acquired by the camera; when a merchandise code is read by the code reader, register the merchandise item identified by the merchandise code in a sales transaction; and when the merchandise item is recognized by the object recognition, register the merchandise item in the sale transaction unless the merchandise item recognized by the object recognition is the same merchandise item most recently registered in the sales transaction when the merchandise code was read by the code reader.

Certain example embodiments will now be described using the drawings.

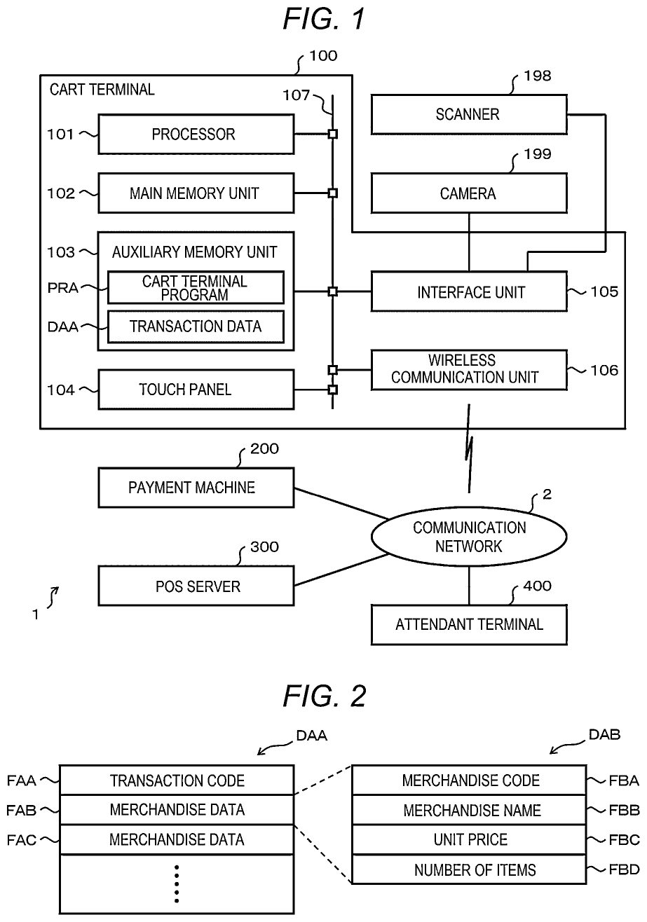

FIG. 1 is a block diagram showing a schematic configuration of a transaction processing system 1. FIG. 1 also depicts a configuration of a cart terminal 100.

The transaction processing system 1 includes the cart terminal 100, a payment machine 200, a POS server 300, and an attendant terminal 400, which can communicate with each other via a communication network 2.

As the communication network 2, one or a suitable combination of the internet, a VPN (virtual private network), a LAN (local area network), a public communication network, a mobile communication network, and the like can be used. In an example, a combination of the internet and a mobile communication network is used as the communication network 2.

Any number of cart terminals 100, payment machines 200, POS servers 300, and attendant terminals 400 may be included in the transaction processing system 1. However, one cart terminal 100, one payment machine 200, one POS server 300, and one attendant terminal 400 are shown in FIG. 1 for simplicity.

The cart terminal 100 is an information processing device installed on a shopping cart (hereinafter referred to simply as a cart) provided at a store. The cart terminal 100 is provided together with the cart to a customer who shops at the store. The cart terminal 100 is an information processing device that accepts an input operation from the customer and executes transaction processing to register a merchandise item which the customer plans to purchase, such an item may be referred to in the following as “a merchandise item to be traded.” The cart terminal 100 is an example of a transaction processing device. In some cases, store staff may be the operator of the cart terminal 100.

The payment machine 200 is an information processing device that is installed at the store and executes payment processing for the settlement of the purchase price of the items registered via the cart terminal 100. The payment machine 200 accepts an input operation from the operator for the payment processing. The operator of the payment machine 200 will typically be the customer. In some cases, store staff may be the operator of the payment machine 200.

The POS server 300 is an information processing device that executes management processing to manage the selling and buying transaction of a merchandise item processed by the transaction processing at the cart terminal 100 and the payment processing at the payment machine 200.

The attendant terminal 400 is an information processing terminal operated by store staff. The attendant terminal 400 is an information processing device providing a user interface related to information processing for supporting a task of store staff related to the transactions processed by the transaction processing system 1. The task of store staff is, for example, the task of monitoring the state of execution of a transaction that is currently being processed and properly supporting the customer during the transaction.

The cart terminal 100 includes a processor 101, a main memory unit 102, an auxiliary memory unit 103, a touch panel 104, an interface unit 105, a wireless communication unit 106, and a transmission line 107 or the like. The processor 101 can communicate with the main memory unit 102, the auxiliary memory unit 103, the touch panel 104, the interface unit 105, and the wireless communication unit 106 via the transmission line 107.

The processor 101, the main memory unit 102, and the auxiliary memory unit 103 are connected together via the transmission line 107.

The processor 101 is equivalent to a central part of a computer and may be a CPU or the like. The processor 101 executes information processing to control each unit and component in order to implement various functions as the cart terminal 100. The information processing thus performed may be accordance with an operating system and an application program or other information processing programs.

The main memory unit 102 includes a read-only memory area and a rewritable memory area. The main memory unit 102 stores a part of the information processing program in the read-only memory area. In some cases, the main memory unit 102 may store necessary data for the processor 101 to execute processing to control each part, in the read-only memory area or the rewritable memory area. The main memory unit 102 uses the rewritable memory area as a work area for the processor 101.

As the auxiliary memory unit 103, for example, an EEPROM (electrically erasable programmable read-only memory), an HDD (hard disk drive), an SSD (solid-state drive), or various other known memory devices can be used. The auxiliary memory unit 103 stores data used by the processor 101 to execute various processing and data generated by the processing by the processor 101. In some cases, the auxiliary memory unit 103 may store the information processing program. In this embodiment, the auxiliary memory unit 103 stores a cart terminal program PRA, which is an information processing program. The cart terminal program PRA is an application program describing procedures of control processing to implement various functions of the cart terminal 100. This control processing includes transaction processing. A part of the memory area of the auxiliary memory unit 103 is used as an area for storing transaction data DAA. The transaction data DAA is data representing g a list of merchandise items that have already been registered in connection with one transaction.

The touch panel 104 displays a screen for showing information to the operator. That is, the touch panel 104 is an example of a display device. The touch panel 104 inputs an instruction based on a touch operation on the screen by the operator.

To the interface unit 105, external devices such as a scanner 198 and a camera 199 are connected. The interface unit 105 interfaces the transmission and reception of data to and from the connected external devices. As the interface unit 105, an existing USB (universal serial bus) controller or the like can be used.

The scanner 198 optically reads optically readable code information such as a one-dimensional barcode and a two-dimensional code (hereinafter referred to as a barcode). As the scanner 198, various known devices such as a type of device using an infrared sensor or a type of device using an image capture device can be used. That is, the scanner 198 is an example of a reading device. Also, an image capture device installed at the same surface as the touch panel 104 of the cart terminal 100 may be used instead of the scanner 198.

The camera 199 captures and acquires an image over an image capture area including the entirety of an internal space of a shopping basket placed on the cart. The camera 199 outputs image data representing the image acquired by image capture. The camera 199 may repeat image capture in a predetermined cycle or may perform image capture in response to an instruction from the processor 101. That is, the camera 199 is an example of an image capture device. Also, an image capture device installed at the surface opposite to the touch panel 104 of the cart terminal 100 may be used instead of the camera 199.

The wireless communication unit 106 executes communication processing to perform wireless data communication via the communication network 2. As the wireless communication unit 106, for example, an existing wireless communication device for wireless LAN can be used. Also, a communication unit connected to the communication network 2 via a wire may be used instead of or in addition to the wireless communication unit 106.

The transmission line 107 includes an address bus, a data bus, and a control signal line or the like, and transmits data and a control signal sent and received between the individual parts connected thereto.

As for the basic hardware of the cart terminal 100, it is assumed that, for example, the hardware of a tablet-type information processing device is used.

FIG. 2 schematically shows the configuration of the transaction data DAA.

The transaction data DAA is generated in connection with a transaction that is currently being processed at the cart terminal 100, and is stored in the auxiliary memory unit 103.

The transaction data DAA includes a field FAA and can also include any number of fields from a field FAB onward. In the field FAA, a transaction code as an identifier of the corresponding transaction is set. If there is a merchandise item that is already registered as a subject of the corresponding transaction, fields FAB, FAC and so on correlated to the merchandise items to be traded, respectively, are added to the transaction data DAA. In the fields FAB, FAC and so on, merchandise data DAB about the individual merchandise items, respectively, are set.

Each merchandise data DAB includes fields FBA, FBB, FBC, FBD. In the field FBA, a merchandise code to the correlated merchandise item to be traded is set. In the field FBB, a merchandise name defined for the merchandise item is set. In the field FBC, the unit price of the merchandise item is set. In the field FBD, the number of items (instances) of the same type (same merchandise code) being purchased is set. The merchandise data may also include various other information such as discount information.

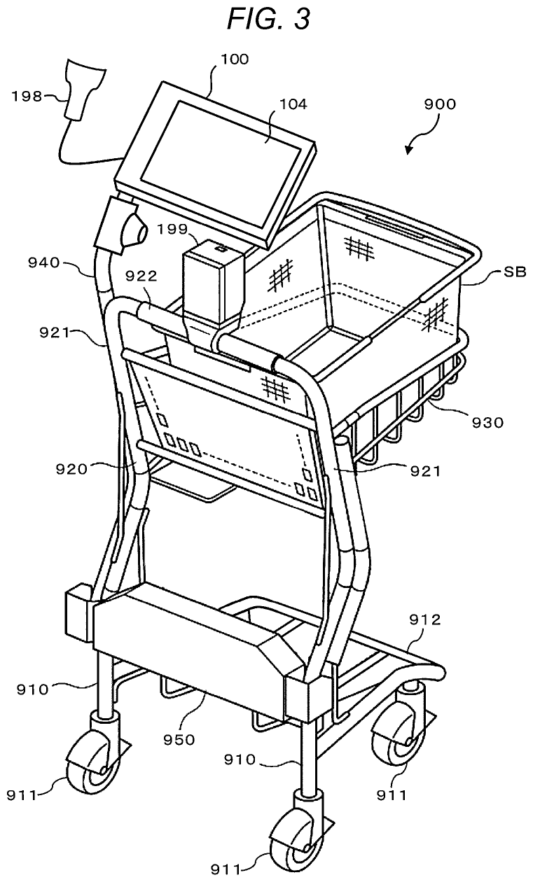

FIG. 3 is a perspective view showing an example of the cart terminal 100 installed on a cart.

A cart 900 has a caster part 910, a handle frame part 920, and a basket holding part 930.

The caster part 910 includes four wheels 911 to smoothly move the cart 900 on a floor surface. The wheels 911 are attached to a frame 912 and are rotatable about a vertical shaft.

The handle frame part 920 includes a pair of vertical frames 921, 921 and a handle bar 922. The vertical frames 921, 921 are provided upright above two wheels of the caster part 910. The handle bar 922 connects the upper ends of the vertical frames 921, 921.

The basket holding part 930 is provided horizontally from a halfway part of the handle frame part 920. The basket holding part 930 holds a shopping basket SB as a container for containing merchandise items. The caster part 910, too, can hold the shopping basket SB on the frame 912. Merchandise items can be contained inside the shopping basket SB located above the basket holding part 930, and the space above the basket holding part 930 is equivalent to and may be referred to as a merchandise storage space.

The customer using the cart 900 is typically located more towards the near side in FIG. 3 than the handle frame part 920. The customer pushes the cart 900, gripping the handle bar 922. That is, in this case, the direction in which the basket holding part 930 protrudes from the handle frame part 920 is the forward direction of the cart 900.

At a halfway part of the handle bar 922, the camera 199 is installed in the state of being able to capture an image of the inside of the shopping basket SB held by the basket holding part 930, from above in a bird's-eye-view manner. The basket holding part 930 of the cart 900 may be changed to a container part in a shape that can directly contain merchandise items, and the camera 199 may capture an image of the inside of this container part in a bird's-eye-view manner. In this case, the space inside the container part is the merchandise storage space. Also, at one vertical frame 921, a pole 940 is attached in such a way that the distal end thereof is located above the handle bar 922. At a distal end part of the pole 940, the cart terminal 100 is attached with such an orientation that the touch panel 104 faces in the direction opposite to the forward direction.

At a lower end side of the handle frame part 920, a battery case 950 is attached between the vertical frames 921, 921. The battery case 950 contains a battery used as an external power supply of the cart terminal 100.

The scanner 198 shown in FIG. 3 is an example of a handheld scanner which the customer using the cart 900 holds in a hand for use. The scanner 198 shown in FIG. 3 is connected to the cart terminal 100 via a cable. However, the scanner 198 may be fixed, for example, to the handle bar 922, in such an attitude as to read a barcode on a merchandise item held from the direction opposite to the forward direction. The scanner 198 may be provided in any form that can read a barcode on a merchandise item that is not put in the shopping basket SB.

The operation of the transaction processing system 1 configured as described above will now be described. The contents of various processing described below are an example. A change in the order of a part of the processing, an omission of a part of the processing, or an addition of another processing or the like can be made according to need. For example, in the description below, the description of a part of the processing is omitted in order to make it easier to understand characteristic operations in this embodiment. For example, if a certain error occurs, processing to cope with the error may be performed, but the description of such processing is omitted.

The customer performs a predetermined operation to start using the cart terminal 100 that is in an unused state. As this operation is performed, the processor 101 starts transaction processing based on the cart terminal program PRA.

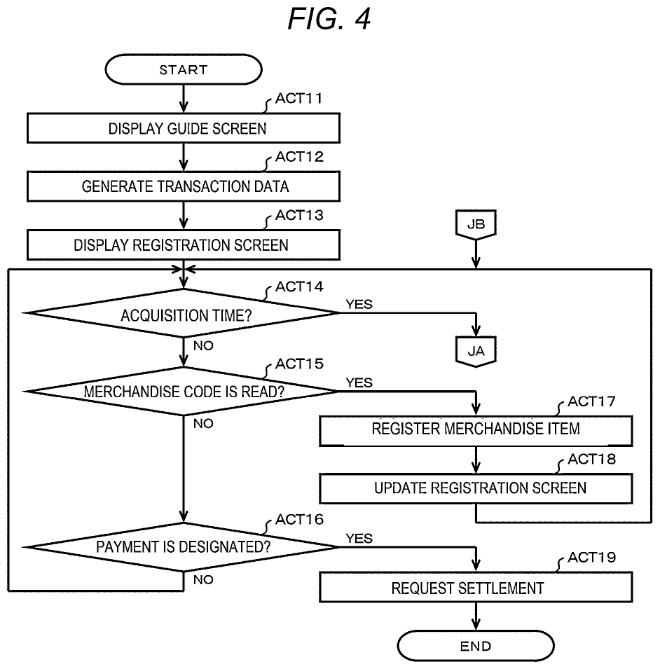

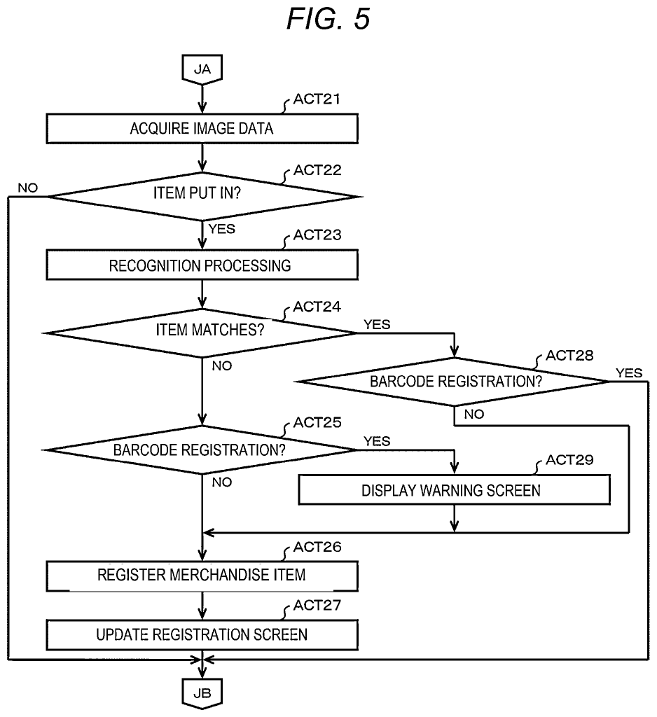

FIGS. 4 and 5 are flowcharts of the transaction processing.

In ACT 11 in FIG. 4, the processor 101 causes the touch panel 104 to display a guide screen. The guide screen is a screen to give the customer a guidance about the status where the cart terminal 100 is now starting for the transaction processing and a guidance about a measure to cope with the case where a merchandise item put in the shopping basket SB is not automatically registered.

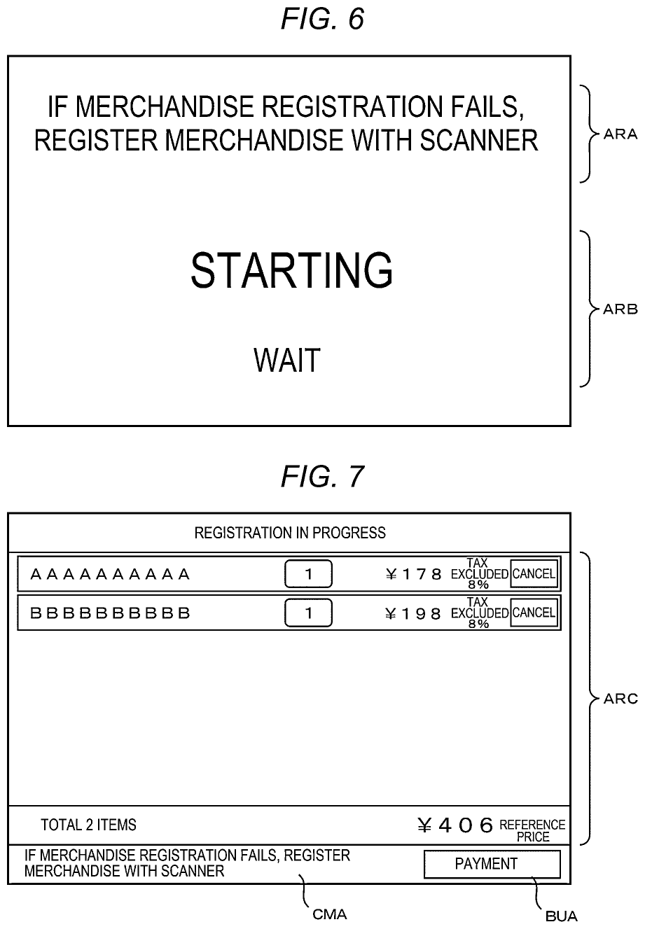

FIG. 6 shows an example of the guide screen.

In the examples of the screen shown in FIG. 6 and other drawings, the illustration of a part of display objects may be omitted.

In the guide screen shown in FIG. 6, a text message shown in an area ARA gives the customer a guidance that if a merchandise item put in the shopping basket SB is not automatically registered, the customer should register the merchandise item, using the scanner 198. Also, in the guide screen shown in FIG. 6, a text message shown in an area ARB gives the customer a guidance about the status where the processing is now starting.

As the processor 101 thus executes information processing based on the cart terminal program PRA, the processor 101 serves as a guide unit. The guidance in this case may be given by another method such as playing a voice message, instead of or in addition to displaying the guide screen.

In ACT 12, the processor 101 generates new transaction data DAA about the target transaction. That is, the processor 101 decides, for example, a new transaction code that is different from transaction codes to identify other transactions, based on a predetermined rule, then generates new transaction data DAA that includes this transaction code but does not include merchandise information about the merchandise item to be traded, and causes the auxiliary memory unit 103 to store the transaction data DAA.

In ACT 13, the processor 101 causes the touch panel 104 to display a registration screen. The registration screen is a screen to allow the customer to recognize the status of registration of the merchandise item to be traded.

FIG. 7 shows an example of the registration screen.

In the registration screen shown in FIG. 7, an image showing the status of registration is arranged in an area ARC.

The registration screen shows a button BUA. The registration screen shows a text message CMA. In the example shown in FIG. 7, the image arranged in the area ARC shows the state where one each of merchandise items with merchandise names “AAAAAAAAAA” and “BBBBBBBBBB”, respectively, and unit prices of 178 yen and 198 yen, respectively, that is, two items in total are already registered, and where a reference price is 406 yen. The reference price is an amount found by subtracting a discount amount based on various services such as a voucher service from the total sum of the unit prices of all the merchandise items to be traded. If the transaction is to be settled without changing the merchandise items to be traded and the service applied, this reference price is the settlement amount. The image arranged in the area ARC changes successively in response to the status of registration of the merchandise item to be traded. However, at the time of execution of ACT 13, no merchandise item has been registered yet and therefore an image that does not show any information about any merchandise item that has been registered and the total number of items is shown as 0 and the reference price of 0 yen is arranged in the area ARC at this time. The button BUA is a soft key for the operator to designate payment request (e.g., end the registration process and finalize the transaction). The text message CMA gives the customer guidance for what to do if a merchandise item that has been put into the shopping basket SB was not automatically registered. Here, text message CMA tells a customer to register such a merchandise item using the scanner 198. The details of the content of the registration screen may be suitably decided, for example, by the developer of the cart terminal program PRA or the like.

As the processor 101 executes information processing based on the cart terminal program PRA, the processor 101 serves as a display control unit.

In ACT 14, the processor 101 checks whether it is the acquisition time of an image or not. If not, the processor 101 determines NO and proceeds to ACT 15. The timing for acquisitions is assumed to be, for example, immediately after the processing proceeds from ACT 13 to ACT 14 or a predetermined time interval after that, or the like. The image acquisition timing may be suitably decided, for example, by the developer of the cart terminal program PRA or the like.

In ACT 15, the processor 101 checks whether a merchandise code has been read by the scanner 198 or not. If not, the processor 101 determines NO and proceeds to ACT 16.

In ACT 16, the processor 101 checks whether payment has been designated or not. If not, the processor 101 determines NO and returns to ACT 14.

Thus, in ACTS 14 to 16, the processor 101 waits until a time for an image acquisition, a merchandise code to be read, or payment (transaction finalization) to be designated.

The customer shops for a merchandise item to buy in

a transaction at the store. The customer then takes the merchandise item to be purchased from a selling location (e.g., a display shelf or the like) and puts the selected merchandise item into the shopping basket SB. Alternatively, the customer may use the scanner 198 to read the barcode of the merchandise item selected from its selling location and then put the selected (and scanned) merchandise item into the shopping basket SB. However, sometimes the customer might not put the merchandise item whose barcode was read by the scanner 198 into the shopping basket SB after the scanning.

Barcode data represented the on barcode a merchandise item includes a merchandise code of the merchandise item. As the barcode is read and the barcode data (the merchandise code) is output from the scanner 198, the processor 101 would thus determine YES in ACT 15 because a merchandise code was read with the scanner 198. The processor 101 then proceeds to ACT 17.

In ACT 17, the processor 101 registers the merchandise item identified by the barcode data as a merchandise item for purchase (an item registered in a sales transaction). The processor 101 updates the transaction data DAA in such a way as to set this merchandise item as one of the merchandise items to be sold in the corresponding transaction. As the processor 101 executes information processing based on the cart terminal program PRA, the processor 101 serves as a first registration unit.

In ACT 18, the processor 101 updates the registration screen in such a way that the image arranged in the area ARC shows the status of transaction as represented by the updated transaction data. The processor 101 generally does not change the button BUA and d the text message CMA in the updated registration screen. After the update, the processor 101 returns to the waiting state of ACTS 14 to 16.

If it is an acquisition time, the processor 101 determines YES in ACT 14 and proceeds to ACT 21 in FIG. 5.

In ACT 21, the processor 101 acquires image data from the camera 199. If the camera 199 repeats image capture on a predetermined cycle, the processor 101 can acquire the latest (most recent) image captured the camera 199. If the camera 199 performs image capture in response to a specific instruction from the processor 101, the processor 101 send the instruction to the camera 199 and acquires image data for the image captured by the camera 199 in response to the instruction. The processor 101 saves the acquired image data in the main memory unit 102 or the auxiliary memory unit 103.

In ACT 22, the processor 101 checks whether a merchandise item was put into the shopping basket SB or not. If not, the processor 101 determines NO and returns to the waiting state of ACTS 14 to 16 in FIG. 4.

If immediately after the processing proceeds from ACT 13 to ACT 14 in FIG. 4 is the first image acquisition time, in many cases, no merchandise item will appear in the acquired image from ACT 21 in FIG. 5. Therefore, if the processor 101 executes ACT 22 for the first time in the transaction, the processor 101 may determine NO and thus returns to the waiting state of ACTS 14 to 16 in FIG. 4. The processor 101 repeats ACTS 21 and 22 in FIG. 5 every time an image acquisition time arrives. The processor 101 may leave the image data acquired by executing ACT 21 within a predetermined past period of time in the main memory unit 102 or the auxiliary memory unit 103 (the previously acquired image data may be referred to as past data).

The processor 101 checks whether there has been a merchandise item newly put into the shopping basket SB or not based on differences between past data and new image data just acquired in ACT 21 (referred to as present data). If there is such a newly added merchandise item, the processor 101 determines that a merchandise item has been put into the shopping basket SB. The processor 101 may also monitor the movement of the hand holding a merchandise item based on the present data and past data, and may then determine whether a merchandise item has been put into the shopping basket SB based on the monitoring of the hand movements as well. If the processor 101 determines that a merchandise item was put into the shopping basket SB, the processor 101 determines YES in ACT 22 and proceeds to ACT 23.

In ACT 23, the processor 101 executes recognition processing on the merchandise item that was just put into the shopping basket SB. For example, the processor 101 sends the present data (most recent image) to an image recognition engine that has been adapted by machine-learned already to recognize products (items) sold at the store. For example, the processor 101 detects a merchandise item in the most recent image and then extracts a visual feature parameter of the detected merchandise item. Then, for example, the processor 101 searches a collation dictionary for data matching the extracted visual feature parameter(s), and sets the merchandise item whose stored feature data matching the extracted feature parameter(s) as a candidate merchandise item when the similarity exceeds some threshold value or the like. As the processor 101 executes information processing based on the cart terminal program PRA, the processor 101 serves a recognition unit.

n ACT 24, the processor 101 checks whether the identified candidate merchandise item matches a previously registered merchandise item. If the candidate merchandise item does not match an already registered item or if no item has been registered yet, the processor 101 determines NO because the candidate merchandise item does not match an already registered merchandise item. The processor 101 then proceeds to ACT 25.

In ACT 25, the processor 101 checks whether the previously registered merchandise item was a barcode registration or not. When the processing proceeds to ACT 25 in response to the putting of a merchandise item into the shopping basket SB without first using the scanner 198 to read its barcode, the processor 101 determines NO and proceeds to ACT 26.

In ACT 26, the processor 101 registers the candidate merchandise item (from ACT 23 recognition processing) as a merchandise item in the transaction. The processor 101 updates the transaction data DAA with the corresponding merchandise item.

In ACT 27, the processor 101 updates the registration screen, as in ACT 18 in FIG. 4. After that, the processor 101 returns to the waiting state of ACTS 14 to 16.

If the customer has another merchandise item to register after the first merchandise item, the customer puts this next merchandise item in the shopping basket SB or uses the scanner 198 to read the barcode of this next merchandise item.

When the barcode of each new (next) merchandise item is read by the scanner 198, the processor 101 executes ACTS 17 and 18 and then returns to the waiting state of ACTS 14 to 16. The processor 101 determines YES in ACT 14 each time the acquisition time arrives, and then proceeds to ACT 21 and executes ACTS 21 to 23 in a manner similar already described. In this case, if a new merchandise item has been put in the shopping basket SB and thus appears in an image represented by the image data acquired in ACT 21 and the subsequent recognition of the new merchandise item is successful in ACT 23, the processor 101 executes processing as described below in response to the action of the customer.

First case: the customer puts a previously registered merchandise item into the shopping basket SB without causing the scanner 198 to read the barcode thereof and then puts a different, unregistered merchandise item into the shopping basket SB without causing the scanner 198 to read the barcode thereof.

The processor 101 will determine NO in both ACTS 24 and 25, then execute ACTS 26 and 27 similarly to the above. The merchandise item that has been newly put in the shopping basket SB will be added to the merchandise items registered for purchase.

Second case: the customer puts a previously registered merchandise item into the shopping basket SB without causing the scanner 198 to read the barcode thereof and then puts another merchandise item that is the same type as the previously registered merchandise item into the shopping basket SB without causing the scanner 198 to read the barcode thereof.

Since in this case the purchase candidate merchandise item matches the previously registered merchandise item, the processor 101 determines YES in ACT 24 and proceeds to ACT 28.

In ACT 28, the processor 101 checks whether the previous registration of the matching merchandise item was based on a barcode registration or not, as in ACT 25. Since in this example this previous registration was not a barcode registration, the processor 101 determines NO in ACT 28 and proceeds to ACT 26. The processor 101 then executes ACTS 26 and 27 similarly to the above and adds the merchandise item newly put in the shopping basket SB to the merchandise items registered for purchase.

Third case: the customer puts a merchandise item whose barcode was read by the scanner 198 into the shopping basket SB.

Since the purchase candidate merchandise item by imaging matches a previously registered merchandise item, the processor 101 determines YES in ACT 24 and proceeds to ACT 28. The processor 101 determines YES in ACT 28 because the previous registration of the merchandise item of the same type was a barcode registration. The processor 101 then returns to the waiting state of ACTS 14 to 16 in FIG. 4 without executing either ACT 26 or ACT 27. That is, the processor 101 does not add another instance of the already registered merchandise item to the merchandise items registered for purchased because this particular merchandise item was already barcode-registered.

Fourth case: the customer does not put a merchandise item whose barcode was just read by the scanner 198 into the shopping basket SB but puts a different merchandise item from that merchandise item into the shopping basket SB without causing the scanner 198 to read the barcode of the new merchandise item.

Since the purchase candidate merchandise item by imaging does not match a previously registered merchandise item, the processor 101 determines NO in ACT 24 in FIG. 5 and proceeds to ACT 25. Since there was previous registration of another merchandise item by barcode registration that has not yet been put into the shopping basket SB, the processor 101 determines YES in ACT 25 and proceeds to ACT 29.

In ACT 29, the processor 101 causes the touch panel 104 to display a warning screen. The warning screen is a screen to give a warning about possibly putting the wrong item into the shopping basket SB or not putting a barcode registered item into the shopping basket SB.

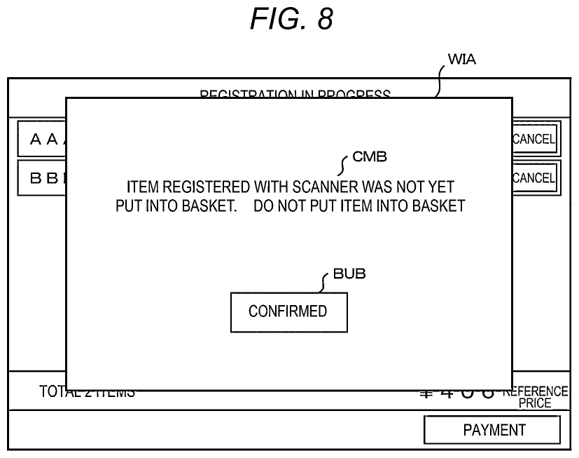

FIG. 8 shows an example of the warning screen.

The warning screen shown in FIG. 8 is a screen showing a window WIA superimposed on the registration screen displayed immediately before on the touch panel 104.

The window WIA shows a text message CMB and a button BUB. The text message CMB warns the customer about the previously barcode-registered merchandise item not being put into the shopping basket SB. The button BUB is a soft key to accept a declaration by the customer that the customer understands the warning given by the text message CMB.

As the processor 101 executes information processing based on the cart terminal program PRA, the processor 101 functions as a warning unit.

The processor 101 waits until a predetermined end condition for the display of the warning screen is satisfied. Once the end condition is satisfied, the processor 101 proceeds to ACT 26 in FIG. 5, executes ACTS 26 and 27 similarly to the above, and adds the merchandise item newly put in the shopping basket SB to the merchandise items for purchase. The end condition may be, for example, that the button BUB is tapped. The end condition may be suitably set, for example, by the developer of the cart terminal program PRA, such as a condition that a predetermined amount of time passes after the warning screen was displayed.

Because the processor 101 executes ACT 26 in the first, second, and fourth cases, the merchandise item recognized in ACT 23 is registered for purchase. That is, as the processor 101 executes information processing based on the cart terminal program PRA, the processor 101 serves as a second registration unit.

As described above, if the customer puts a merchandise item whose barcode was read by the scanner 198 into the shopping basket SB before putting any other merchandise item into the shopping basket SB, the processing in the third case is performed and this prevents a duplicate registration of the previously barcode-registered merchandise item that might otherwise occur based on the recognition in ACT 23.

However, if the customer puts another merchandise item into the shopping basket SB after registering a merchandise item with the scanner 198, the processing in the third case is not performed and the processing in the first case or the second case can be performed, posing a risk of duplicate registration. To cope with this possibility, a warning is given to the customer via the warning screen and duplicate registration may thus be prevented.

When payment is designated by a predetermined operation such as a tap on the button BUA shown on the registration screen, the processor 101 determines YES in ACT 16 in FIG. 4 and proceeds to ACT 19.

In ACT 19, the processor 101 requests, for example, the payment machine 200 to settle the transaction including all the registered merchandise items. That is, the processor 101 sends, for example, the transaction data to the payment machine 200 and requests the payment machine 200 to perform settlement processing. If a settlement terminal is installed on the cart 900 and connected to or integrated with the cart terminal 100, the processor 101 may calculate the settlement amount (transaction amount due) and then request the settlement of the amount by credit card settlement, code settlement or the like. Alternatively, the processor 101 may calculate an amount to be settled and then request an online settlement server handle settlement processing for the amount due.

As described above, the customer may simply put a merchandise item into the shopping basket SB to register the item for purchase or the customer may use the scanner 198 to read a barcode on the merchandise item being purchased. The cart terminal 100 does not perform duplicate registration even when a merchandise item whose barcode was just read by the scanner 198 is put into the shopping basket SB. Thus, the efficiency of registration of merchandise items with a frictionless cart can be improved without substantially increasing the burden on the operator.

Also, the cart terminal 100 displays a warning screen to warn the customer to prevent duplicate registrations as described above.

The cart terminal 100 can also allow the customer to recognize, before starting shopping, that merchandise registration using the scanner 198 is available if a particular merchandise item cannot be registered visually (by image analysis) when the merchandise item is put in the shopping basket SB, via the guide provided as the text message shown in the area ARA on the guide screen.

The cart terminal 100 can also allow the customer to constantly recognize, during merchandise registration, that merchandise registration using the scanner 198 is available via the text message CMA shown in the registration screen.

This embodiment can be implemented with various modifications such as described below.

A part of the processing executed by the processor 101 in a foregoing embodiment may be executed by the POS server 300 or one or more other processing devices. For example, the cart terminal 100 may execute only a user interface operation, and the POS server 300 may execute various information processing to identify a merchandise item being purchased. That is, described functions of the recognition unit, the first registration unit, the second registration unit, the warning unit, the guide unit, and the display control unit may be provided by any information processing device included in the transaction processing system 1, other than the cart terminal 100, or may be suitably distributed among a plurality of information processing devices included in the transaction processing system 1.

A part or all of the functions implemented by the processor 101 based on information processing can be implemented as hardware that executes information processing which is not based on a program, such as a dedicated logic circuit or the like. Each of the described functions can also be implemented by a combination of hardware and software control.

What is claimed is:

1. A transaction processing system, comprising:
a camera on a cart and positioned to capture images of merchandise items in a merchandise storage space of the cart;
a code reader on the cart and configured to read merchandise codes from merchandise items; and
a processor configured to:
perform object recognition to recognize a merchandise item based on visual features of the merchandise item depicted in an image acquired by the camera;
when a merchandise code is read by the code reader, register the merchandise item identified by the merchandise code in a sales transaction; and
when the merchandise item is recognized by the object register the merchandise item in the sale recognition, transaction unless the merchandise item recognized by the object recognition is the same merchandise item most recently registered in the sales transaction when the merchandise code was read by the code reader.

2. The transaction processing system according to claim 1, wherein the processor is further configured to:
cause a warning to be output when the first merchandise item recognized by the object recognition directly after a merchandise item is registered in the sales transaction when the merchandise code is read by the code reader is different from the merchandise item corresponding to the merchandise code read by the code reader.

3. The transaction processing system according to claim 2, further comprising:
a display screen on the cart, wherein
the warning is output to the display screen.

4. The transaction processing system according to claim 3, wherein the warning is output on the display screen as a popup window with a confirmation button.

5. The transaction processing system according to claim 1, further comprising:
a display screen on the cart, wherein
the processor is further configured to:
cause the display screen to display a user guiding message suggesting that the code reader can be used to register merchandise items if object recognition of merchandise items is unsuccessful.

6. The transaction processing system according to claim 5, wherein the user guiding message is displayed on the display screen before a start of a merchandise registration process.

7. The transaction processing system according to claim 5, wherein the user guiding message is displayed continuously on the display screen during a merchandise registration process.

8. The transaction processing system according to claim 1, wherein the processor is further configured to:
cause a display screen to display a user guiding message suggesting that the code reader can be used to register merchandise items if object recognition of merchandise items is unsuccessful.

9. The transaction processing system according to claim 1, further comprising:
a display screen on the cart and connected to the processor.

10. A cart-mounted transaction processing device, comprising:
a camera interface connectable to a camera mounted on a cart, the camera positioned to capture images of merchandise items in a merchandise storage space of the cart;
a code reader interface connectable a code reader mounted on the cart, the code reader being configured to read merchandise codes from merchandise items; and
a processor configured to:
cause object recognition processing to be performed to recognize a merchandise item based on visual features of the merchandise item depicted in an image acquired by the camera;
when a merchandise code is read by the code reader, register the merchandise item identified by the merchandise code in a sales transaction; and
when the merchandise item is recognized by the object recognition processing, register the merchandise item in the sale transaction unless the merchandise item recognized by the object recognition processing is the same merchandise item most recently registered in the sales transaction when the merchandise code was read by the code reader.

11. The cart-mounted transaction processing device according to claim 10, wherein the processor is further configured to:
cause a warning to be output when the first merchandise item recognized by the object recognition directly after a merchandise item is registered in the sales transaction when the merchandise code is read by the code reader is different from the merchandise item corresponding to the merchandise code read by the code reader.

12. The cart-mounted transaction processing device according to claim 11, further comprising:
a display screen, wherein
the warning is output to the display screen.

13. The cart-mounted transaction processing device according to claim 10, further comprising:
a display screen, wherein
the processor is further configured to:
cause the display screen to display a user guiding message suggesting that the code reader can be used to register merchandise items if object recognition of merchandise items is unsuccessful.

14. The cart-mounted transaction processing device according to claim 13, wherein the user guiding message is displayed continuously on the display screen during a merchandise registration process.

15. The cart-mounted transaction processing device according to claim 10, wherein the processor is further configured to:
cause a display screen to display a user guiding message suggesting that the code reader can be used to register merchandise items if object recognition of merchandise items is unsuccessful.

16. The cart-mounted transaction processing system according to claim 10, further comprising:
a display screen; and
a wireless interface connectable to a point-of-sale server configured to register merchandise items in the sales transaction.

17. A method for a transaction processing device in a transaction processing system, the method comprising:
performing object recognition to recognize a merchandise item based on visual features of the merchandise item depicted in an image acquired by a camera mounted on a shopping cart and positioned to acquire images of a merchandise storage location of the shopping cart;
when a merchandise code is read by a code reader mounted on the shopping cart, registering the merchandise item identified by the merchandise code in a sales transaction; and
when the merchandise item is recognized by the object recognition, registering the merchandise item in the sale transaction unless the merchandise item recognized by the object recognition is the same merchandise item most recently registered in the sales transaction when the merchandise code was read by the code reader.

18. The method according to claim 17, further comprising:
causing a warning to be output when the first merchandise item recognized by the object recognition directly after a merchandise item is registered in the sales transaction when the merchandise code is read by the code reader is different from the merchandise item corresponding to the merchandise code read by the code reader.

19. The method according to claim 18, wherein the warning is output to a display screen mounted on the shopping cart.

20. The method according to claim 17, further comprising:
causing a display screen to display a user guiding message suggesting that the code reader can be used to register merchandise items if object recognition of merchandise items is unsuccessful.
